(19) United States
(12) Patent Application Publication
(10) Pub. No.: US 2026/0276815 A1
(43) Pub. Date: Sep. 17, 2026

(54) OPTICAL SENSOR DEVICE FOR FAULT DETECTION IN MECHANICAL WEED CONTROLLERS AND SUBSOILERS

(71) Applicant: Marcelo Roberto Pividori, Provincia de Santa Fe (AR)

(72) Inventor: Marcelo Roberto Pividori, Provincia de Santa Fe (AR)

(21) Appl. No.: 19/202,027

(22) Filed: May 8, 2025

(30) Foreign Application Priority Data
Mar. 17, 2025 (AR) AR20250100703

(51) Int. Cl. G01S 17/08; A01B 35/08

(52) U.S. Cl. CPC G01S 17/08; A01B 35/08

(57) ABSTRACT

An optical sensor device for detecting faults in mechanical weeders and subsoilers supported by a support bracket attached to the frame, The optical sensor device (8) includes a tubular housing with an infrared guide (10), inside which an electronic circuit (13) connected to a transmitting infrared LED (15) and a receiving phototransistor (16) arranged in parallel is housed. The tubular housing with the infrared guide (10) is protected by a polycarbonate protective lens (14) and closed with a cap (11), where the mentioned optical sensor device (8) is fixed by a mounting base (9) and connected through a power and data cable (12), which is integrated into a LIN network linking it to the operator's control panel.

### TECHNICAL FIELD OF THE INVENTION

This application relates to the preparation of agricultural fields for planting crops, which involves conditioning the soil to optimize soil density, increase nutrients, decompaction of the soil to improve soil aeration, and mechanically eliminate weeds to promote plant growth without the use of agrochemicals.

The soil conditioning process involves using agricultural machinery equipped with tillage tools that are towed by a tractor. These tools are equipped with ground-penetrating implements that weed, break up, and aerate the soil, enhancing water infiltration and effectively drying out weeds by severing their roots.

Agricultural implements particularly include mechanical weeders and subsoilers, which remove soil without turning it over. In these machines, tools such as blades, discs, and shares are mounted on a toolbar.

### Background of the Invention and Problems to be Solved

Specialized publications on precision agriculture recommend the efficient and responsible use of mechanical weed control as an alternative to reduce the use of agrochemicals in crops. Additionally, they address the problem of the development of weeds highly resistant to agrochemicals, such as those of the “Amaranthus” type, for which mechanical extraction is suggested as the best solution.

The difference between mechanical weeders and subsoilers is based on the depth of penetration and the objective sought to be achieved.

Common features of mechanical weeders and subsoilers include the following parts of an agricultural implement: at least one frame (chassis) (1) to which a support bracket (3) is attached, connected to a blade holder or plate (4) that supports at least one main cutting blade (5) in a “V” shape mounted at the lower end of the furrow opener. The blade (5) is connected by a pivoting bolt (6) and a safety bolt (7) to the blade holder (4).

In their working position, mechanical weeders operate at a depth of between 5 cm and 15 cm, while subsoilers work at a depth of between 30 cm and 70 cm below the soil line. In the event that both tools encounter an obstacle they cannot remove, they change position, resulting in them being out of their working position after the safety pin (7) is disengaged and they pivot on the pivoting bolt (6) to avoid damage to the agricultural implement.

The state of the art recognizes different devices that refer to the application of non-contact means to protect a tillage implement.

The use of tilling depth control means in a subsoiler, which include a height measurement sensor, an angle measurement sensor, and a microprocessor associated with an acoustic and visual alarm, where the height measurement sensor is mounted on the frame of the subsoiler, and the angle sensor is mounted on a leveling wheel support of the subsoiler. These sensors are used to obtain the height value between the frame and the ground, and they send the height value to the microprocessor. The angle measurement sensor is used to obtain the angle value between the side of the leveling wheel support and the vertical line perpendicular to the ground, sending the angle value to the microprocessor to determine the tillage depth of the cultivated soil according to the height value and angle value using a comparison method, associated with an acoustic or visual alarm that emits a signal based on the depth value of the cultivated soil compared to the pre-established value stored in the microprocessor.

Among the position sensors for determining the working depth of an agricultural implement, a height sensor is used to measure, without contact, the height position of the frame with respect to the ground surface, associated with a control unit, to receive a signal from the height sensor and to control the height position of the leveling wheel. This includes a tool position sensor positioned to measure the orientation of the tool in relation to the frame. The control unit receives the signal from the tool position sensor and calculates the working depth of said tool based on the signal from the height sensor and the signal from the tool position sensor.

The use of soil sensors that utilize a shank to penetrate the ground surface, associated with a sensor fixed to the outer surface of the shank body that defines a sensing area. These sensors include a sensor guard attached in front of the sensor to the shank body, designed to deflect the soil flow away from the sensor without interrupting the soil flow towards the sensing area. These sensors are used to quantify nitrate-N values in the soil.

The document considered close to this application is document US2017196160 (A1), published on Jul. 13, 2017, held by PRECISION AG 360 INC [US], titled: “Agricultural Ground Penetrating Tool Sensor System,” which discloses: “1. A monitoring system for an agricultural tool includes a plate coupled within the agricultural tool. A shank pivotably connected to the plate via a pivot bolt extending through the plate and the shank. A first sensor device is coupled to the shank, and a second sensor device is coupled to the plate and aligned with the first sensor device when the shank is in a ripping position. An alarm attached to at least one of the first and second sensors and configured to notify when the shank is changed to a pivoted position such that the first and second sensor devices are no longer aligned.”

The problem posed is that the operator is unable to visually identify whether a blade, share, or chisel has shifted from its working position due to a failure of the safety pin. This is because the work is conducted underground without any visible markings on the ground, and the change in position of the tool is not observable from the operator's working position.

Over time, shear pins often experience fatigue and eventually fail due to working conditions. Generally, the operator does not detect a broken shear pin until well after the event that caused the safety pin to shear, resulting in a significant area of soil that remains unconditioned and increasing the time the agricultural implement is out of operation until the safety pin is replaced. This hinders timely intervention to resolve the issue, resulting in the undesirable effect of portions of the field surface being left unplowed or uncompacted, leading to ineffective performance and subsequent losses in agricultural production.

In a mechanical weeder, this effect will only be noticeable a few days after the work in the field has been completed because all the weeds in the areas where the work was carried out correctly will have dried out. In contrast, the weeds in the work lines where the shear pin failed, and the blade was out of its working position, will not have dried.

In a subsoiler, this consequence will become noticeable after a rain, when the lack of water penetration becomes apparent, and later in the negative impact on crop development due to the difference in soil compaction.

In order to address this problem, an optical sensor device has been developed to detect faults in mechanical weeders and subsoilers. This device operates by emitting an infrared light beam that, under normal working conditions, is reflected off the blade-holding arm. A receiving phototransistor detects this reflected signal, and the information is processed by a microcontroller. Depending on the configuration and detection status, the sensor indicates whether the blade-holding arm is in the correct working position or has shifted out of position due to a failure, identifying the position on the line “row” [“linio” in Spanish] in the control panel.

It allows the operator to be notified in real-time of the operational status of each blade mounted at the lower end of the furrow-opening toolbar. When one of the blades shifts out of its working position and becomes inoperative, it alerts the operator regarding the line and the blade where the event occurred, prompting them to stop work, replace the safety pin, and reactivate the control body. This improves the utility of mechanical weeders and subsoilers, enhancing their efficiency in performing their functions.

Given the characteristics of these machines and the working conditions, a sensor is defined that can be operational and easily installed, positioned in such a way that it is not affected by weeds and can detect (“sensing” in English) at a distance without contact. Additionally, it should be adaptable to the various designs of different agricultural machinery manufacturers, featuring a simple design for eventual replacement.

Component Reference Table

| Component | Reference No. |
|---|---|
| Frame | (1) |
| Parallelogram | (2) |
| Support bracket | (3) |
| Blade Holder | (4) |
| Blade | (5) |
| Pivoting Bolt | (6) |
| Safety Pin | (7) |
| Optical Sensor Device | (8) |
| Mounting Base | (9) |
| Tubular Housing with | (10) |
| Infrared Guide | |
| Cover | (11) |
| Power and Data Cable | (12) |
| Electronic circuit | (13) |
| Polycarbonate Protector | (14) |
| Infrared LED | (15) |
| Receiving Phototransistor | (16) |
| Coupling Device | (17) |
| Power Supply | (18) |
| Microcontroller | (19) |
| Communication Interface | (20) |
| Signal Amplifier | (21) |
| Infrared Emitter | (22) |
| Infrared Receiver | (23) |

### DESCRIPTION OF THE FIGURES

For greater clarity and understanding of the object of this patent application, it has been illustrated in the following figures, represented in one of the preferred embodiments. This is for exemplification purposes only and does not imply limitations to the scope of protection of this patent application, where:

FIG. 1: A perspective view from above shows the parts comprising a mechanical weeder: the frame (1) associated with the parallelogram (2) fixed to the support bracket (3), coupled with the blade-holding arm (4) that supports the blade (5) through the pivoting bolt (6) and the safety pin (7). The arrangement of the optical sensor device (8) can be seen, positioned over and inserted into the support bracket (3). In an enlarged view, the arrangement of the optical sensor device (8), mounted on the support bracket (3) and oriented inwardly, is illustrated in detail.

FIG. 2: A lateral cross-sectional view of a mechanical weeder is shown, highlighting the component parts: the blade (5), supported by the blade-holding arm (4) in its working position below the soil line, and the arrangement of the optical sensor device (8), positioned over and inserted into the support bracket (3) and close to the blade-holding arm (4). A close-up view distinguishes the proximity between the optical sensor device (8) and the blade-holding arm (4).

FIG. 3: A lateral cross-sectional view of a mechanical weeder is shown, illustrating the blade support arm (4) out of its working position at the soil line, after cutting the safety pin (7) and pivoting on the pivoting bolt (6) in the presence of an obstacle. A close-up view reveals the separation between the optical sensor device (8) and the blade-holding arm (4).

FIG. 4: Positional views of the assembled optical sensor device (8) are presented.

FIG. 4-A shows a frontal view shows the tubular housing with an infrared guide (10) and the mounting base (9).

FIG. 4-B shows a rear view is displayed, showing the mounting base (9), the cover (11), and the power and data cable (12).

FIG. 5: An exploded view of the optical sensor device (8) is presented, illustrating its components: a tubular housing with an infrared guide (10), which houses an electronic circuit (13) connected to an emitting infrared LED (15) and a receiving phototransistor (16), both arranged in parallel. The housing is protected by a polycarbonate cover (14) and is sealed with a cap (11). The optical sensor device (8) is mounted securely using the base (9) and connects through a power and data cable (12).

FIG. 6: A cross-sectional view of the assembled optical sensor device (8) is shown, displaying the arrangement of its components: the tubular housing with an infrared guide (10), the electronic circuit (13), the emitting infrared LED (15), and the receiving phototransistor (16) arranged in parallel. The polycarbonate cover (14), the cap (11), the mounting base (9), and the power and data cable (12) are also visible.

FIG. 7: A cross-sectional view of the optical sensor device (8) coupled to the support bracket (3) in front of the blade-holding arm (4) is shown, illustrating the operating principle of the optical sensor device (8) to detect the proximity of the blade-holding arm (4). The emission signals from the infrared LED (15) can be seen reflecting off the blade-holding arm (4), and the signal received by the phototransistor (16) is processed by the electronic circuit (13), enabling the detection of the proximity of the blade-holding arm (4).

FIG. 8: A cross-sectional view is presented to illustrate the operating principle of the optical sensor device (8), showing that the emission signals from the infrared LED (15) do not generate reflection on the blade-holding arm (4) due to the absence or distance of the blade-holding arm (4). Therefore, the receiving phototransistor (16) does not detect any reflection of the emission signals from the infrared LED (15) because it is outside the range of values configured in the electronic circuit (13), indicating the absence of the blade-holding arm (4).

FIG. 9: A schematic diagram of the electronic circuit (13) is shown, detailing its components and subsystems: a power supply (18), a microcontroller (19), a communication interface (20), a signal amplifier (21), an infrared emitter (22), and an infrared receiver (23).

FIG. 10: Illustrates a block diagram with the signals obtained using an oscilloscope during tests conducted with the optical sensor device (8) on a mechanical weeder, where the following can be observed: Three time-synchronized graphs illustrate the operation of the optical sensor device (8) as it detects the proximity of a blade holder (4) using infrared light. The horizontal axis of all three graphs represents time in milliseconds (ms), while the vertical axes, along with the plotted signals, are explained as follows: Upper Graph (24): Signal Emitted by the Infrared LED (15): Displays a series of regular square pulses with a repetition frequency of 100 Hz and a duty cycle of 10%, representing the control signal applied by the microcontroller (19) to the infrared emitter (22) of the sensor. The constant pulse amplitude indicates that the emission of the infrared LED (15) is stable. Central Graph (25): Detected and Processed Signal: Shows the signal captured by the sensor after reflecting off the blade holder (4). It can also be observed that the amplitude of the detected pulses varies, indicating changes in the distance or reflectivity of the blade holder. The red dotted horizontal line represents the Proximity threshold set by the user, specific to this agricultural implement, indicating the change in the sensor's state. The first three detected pulses have an amplitude above the proximity threshold, maintaining the ON state, while from the fourth pulse onward, the amplitude of the detected signal falls below the Proximity threshold, which is reflected in a state change from ON to OFF. A lower amplitude suggests that the blade holder is moving away from the correct position. Lower Graph (26): State Interpreted by the Microcontroller: This graph displays the interpretation of the state (ON/OFF) made by the microcontroller (19) based on the detected signal, considering the Normal Operating Mode and the proximity threshold for this implement, keeping synchronization with the previous signals, which is reported to the control panel via the communication interface (20).

FIG. 11: Illustrates a block diagram identical to FIG. 10) previously described, featuring signals obtained using an oscilloscope during tests conducted with the optical sensor device (8) on a subsoiler, where the following can be observed: In the Central Graph (25), the blade-holding arm (4) starts from a distant position, resulting in no reflection. This represents the correct working position for this agricultural implement, as it begins in an Inverted Operating Mode, so that when it exits its proper working position by pivoting on the pivot bolt (6), the blade-holding arm (4) approaches the location of the optical sensor device (8). Lower Graph (26): State Interpreted by the Microcontroller: This graph displays the interpretation of the state (ON/OFF) made by the microcontroller (19) based on the detected signal, considering the Inverted Operating Mode and the proximity threshold set by the user for this agricultural implement, maintaining synchronization with the previous signals, which is reported to the control panel via the communication interface (20).

FIG. 12: Shows three positional views of the components that make up a subsoiler.

FIG. 12-A shows a top perspective view in showing the frame (1), the support bracket (3), the blade-holding arm (4), the blade (5), the pivoting bolt (6), and the safety pin (7), with the optical sensor device (8) fixed by the mounting base (9) through the coupling device (17), attached to the support bracket (3).

FIG. 12-B shows a bottom perspective shows the arrangement of the optical sensor device (8), where it can be distinguished that the tubular housing with an infrared guide (10) is inserted into the hole of the coupling device (17).

FIG. 12-C shows an exploded view showing the optical sensor device (8) is shown coupled through the mounting base (9) onto the coupling device (17).

FIG. 13: shows positional views of a subsoiler to illustrate the operating principle of the optical sensor device (8).

FIG. 13-A shows a detailed lateral view of a subsoiler in its working position is presented, moving from right to left (indicated by an arrow), where the blade (5) is located below the soil line. The position of the blade-holding arm (4), the support bracket (3), and the frame (1) can be observed. The optical sensor device (8) is positioned perpendicular to the ground and is coupled via the coupling device (17), positioned over and inserted into the support bracket (3), showing that the blade-holding arm (4) is distant from the optical sensor device (8).

FIG. 13-B shows a lateral view of the tubular housing with an infrared guide (10) is clearly visible, inserted into the hole of the coupling device (17) and oriented vertically, plumb to the ground, where the blade-holding arm (4) is outside the proximity detection threshold of the optical sensor device (8).

FIG. 13-C presents a detailed front cross-section of a subsoiler where the absence of the blade-holding arm (4) in relation to the optical sensor (8) is evident.

FIG. 14: Shows three positional views of the subsoiler to illustrate the operating principle of the optical sensor device (8).

FIG. 14-A shows a detailed lateral view of a subsoiler is shown where the blade-holding arm (4) is moved from right to left, outside its working position relative to the soil line, after severing the safety pin (7) and pivoting on the pivot bolt (6) due to an obstacle.

FIG. 14-B shows the distance of the optical sensor device (8), adjacent to the blade-holding arm (4).

FIG. 14-C presents a detailed front cross-section of the subsoiler, illustrating the proximity of the blade-holding arm (4) to the optical sensor (8).

### DETAILED DESCRIPTION OF THE INVENTION

Common features of mechanical weeders and subsoilers include the following shared parts of an agricultural implement: at least one frame (1) to which a support bracket (3) is attached, linked to a blade holder or plate (4) that supports at least one blade (5), which is connected by a pivoting bolt (6) and a safety pin (7) to the blade holder (4).

This application refers to an optical sensor device (8) that allows for the detection of the proximity of the blade-holding arm (4) relative to the optical sensor device (8) within the operational parameters defined by design, using as a reference the configuration parameters set by the user, which are stored in the internal memory of the microcontroller (19). This enables it to report the status of the blade-holding arm (4) through LIN-formatted messages via the communication interface (20). The possible states are ON and OFF, defined by user-adjustable configuration parameters within the design's permitted margins, through a control panel or mobile application. It is understood that the ON state indicates that the blade-holding arm (4) is in the correct working position, while the OFF state signifies an incorrect working position. The operational parameters are the minimum and maximum distances that the optical sensor device (8) can discern, which are defined during the physical and electronic design. The configuration parameters defined by the user include the mode of operation: if the ON state occurs due to the presence of the blade-holding arm (4), it is referred to as Normal; conversely, if it occurs due to the absence of detection of the blade-holding arm (4), it is referred to as Inverted. Additionally, the parameters specify the proximity distance at which the state changes from ON to OFF, or vice versa. These configuration options give the optical sensor device (8) the versatility to adapt and be utilized in different types of agricultural implements that share the common parts found in Mechanical Weeders and Subsoilers.

### Differences in the Arrangement and Operation of the Optical Sensor

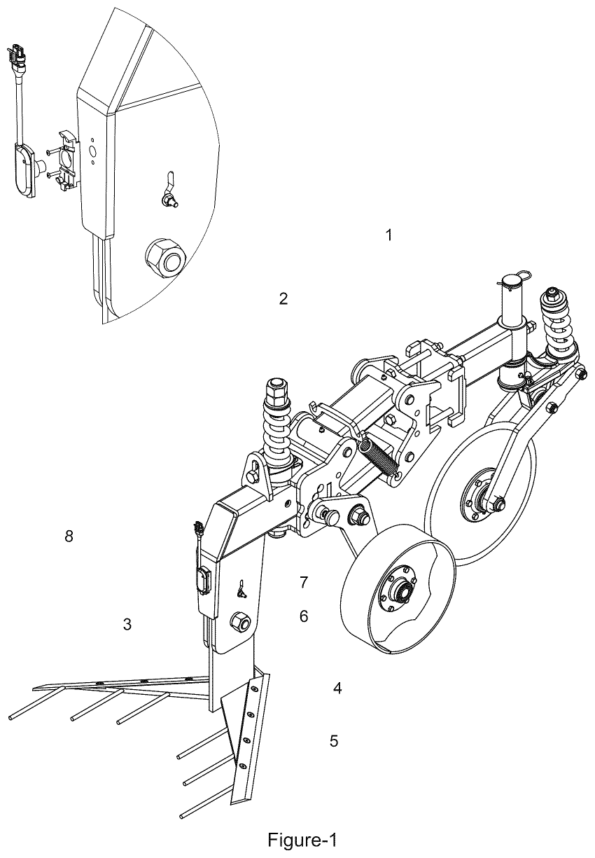

In a mechanical weeder, the optical sensor device (8) is mounted on the support bracket (3), secured by its base (9), and oriented inwardly toward its inner face to detect the proximity of the blade-holding arm (4). The device interprets that the normal (correct) working position is when the blade-holding arm (4) is detected to be close to the optical sensor device (8), indicating that it is operating in Normal Operating Mode. The device transmits an ON state while proximity is detected and an OFF state when proximity is not detected (FIG. 1).

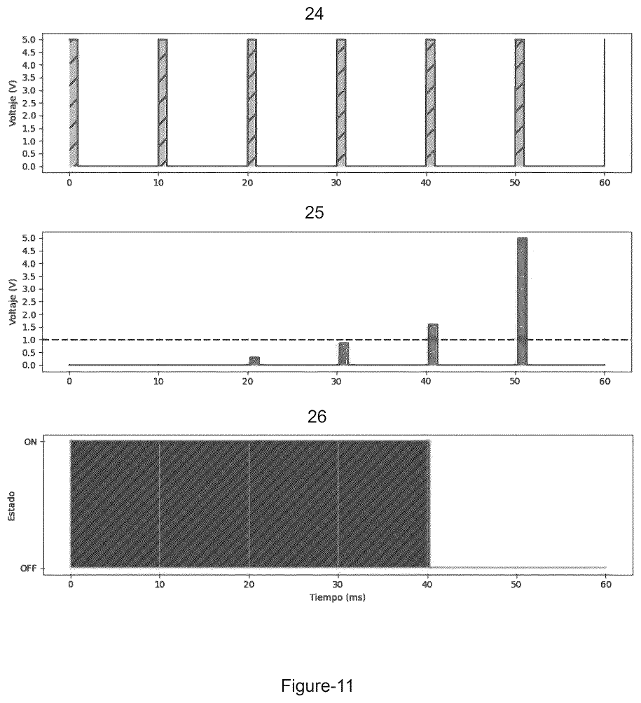

In a subsoiler, there is a need to incorporate a coupling device (17), attached to the support bracket (3) and to the mounting base (9) where the optical sensor device (8) is fixed. This optical sensor device allows for the detection of the proximity of the blade-holding arm (4) in the event that the safety pin (7) breaks, operating inversely compared to the mechanical weeder, i.e., it operates in Inverted Operating Mode, with the normal (correct) working position defined as when the optical sensor device (8) does NOT detect the proximity of the blade-holding arm (4). The device transmits an OFF state when proximity is detected and an ON state when proximity is not detected (FIG. 11).

### Description of the Optical Sensor Device

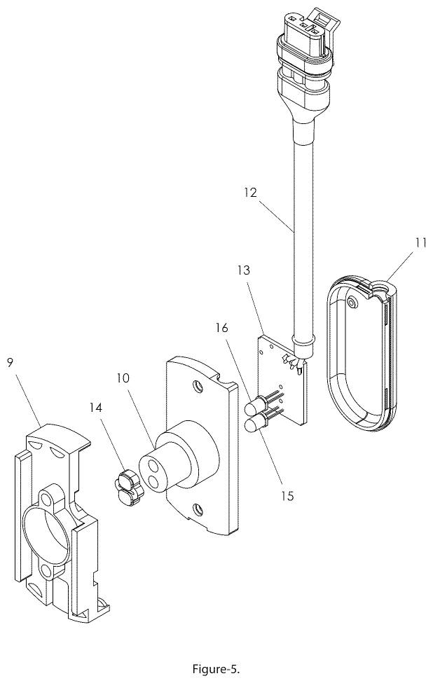

The optical sensor device (8) consists of a tubular housing with an infrared guide (10), inside which is housed an electronic circuit (13) connected to an emitting infrared LED (15) and a receiving phototransistor (16), arranged in parallel. The housing is protected by a polycarbonate cover (14) and is sealed with a cap (11), while the device is secured using the mounting base (9) and connected via a power and data cable (12) to the control panel's command board, equipped with the necessary means for its operation (FIG. 5).

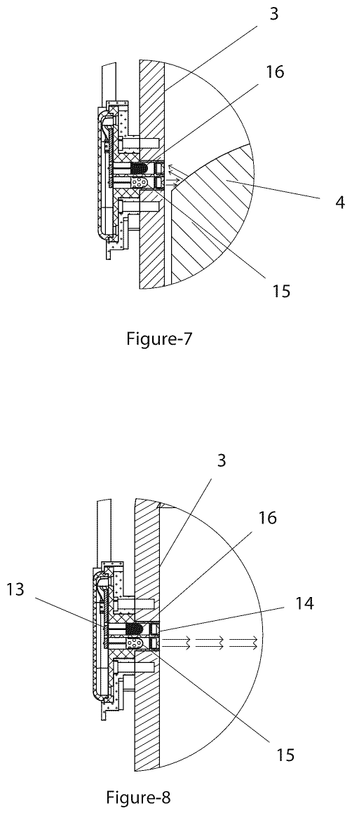

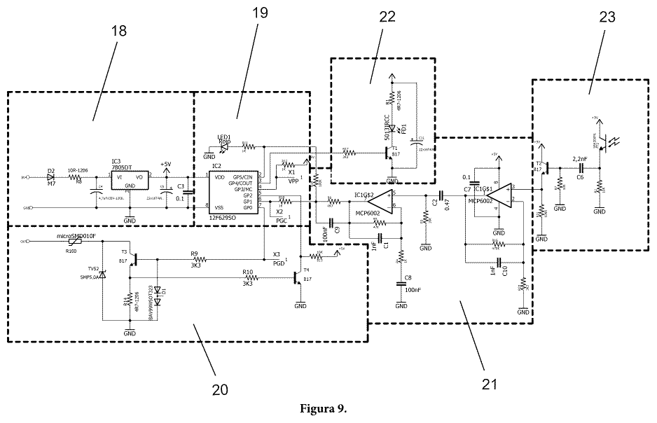

The tubular housing with an infrared guide (10) serves to align the emitting infrared LED (15) and the receiving phototransistor (16) in parallel, and to correctly direct both the outgoing light beam emitted by the infrared LED (15) and the incoming light beams toward the receiving phototransistor (16). The tubular housing with an infrared guide (10) is black and features a tubular design with two compartments where the emitting infrared LED (15) and the receiving phototransistor (16) are positioned. This design concentrates the incoming and outgoing light beams, prevents internal reflections, and minimizes external interferences typical of the environment to which the sensor will be exposed (FIGS. 7-8).

The polycarbonate protective lenses (14) are positioned at the outer end of the tubular housing with an infrared guide (10), as they serve the function of lenses with physical filtering, which is possible due to the material from which they are made. At the same time, they protect the emitting infrared LED (15) and the receiving phototransistor (16) from the environmental conditions to which the sensor is exposed.

The electronic circuit (13) consists of sections, each performing its specific function while interrelating to achieve the necessary purpose. These sections include: a power supply (18), which maintains the appropriate operational voltage levels for the correct functioning of the entire electronic circuit (13); a communication interface (20), where the electrical signals are adjusted for transmitting and receiving information via the LIN communication protocol; an infrared emitter (22), which houses the infrared LED (15) along with its transistor activation control; an infrared receiver (23), which contains the receiving phototransistor (16) along with its auxiliary electronic components that enable its proper operation; a signal amplifier (21), which takes the signal generated by the infrared receiver (23), filters it, and adjusts it to the appropriate voltage levels so that it can be interpreted by the electronic circuit (13); and a microcontroller (19), equipped with the necessary auxiliary electronic components for its operation. The microcontroller is responsible for receiving configuration parameter adjustments via the communication interface (20), generating control signals for the infrared emitter (22), reading signals from the signal amplifier (21) that were received by the infrared receiver (23), analyzing the received information based on the configuration parameter values stored in its internal memory to determine the operating status, and transmitting the detected state (ON/OFF) via the communication interface (20). The electronic circuit (13) is coupled to the tubular housing with the infrared guide (10) through the infrared LED (15) and the receiving phototransistor (16), which are soldered onto it, and to the power and data cable (12), which has its three wires soldered to the electrical pads of the electronic circuit (13) for that purpose (FIG. 5).

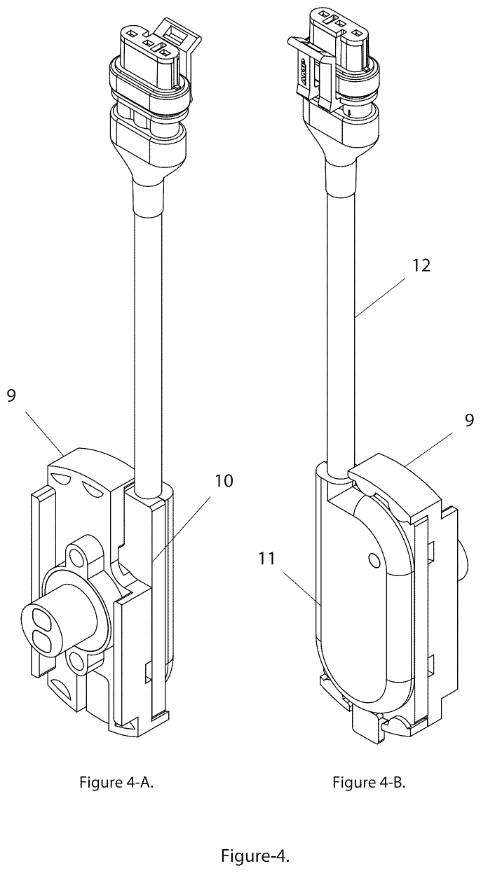

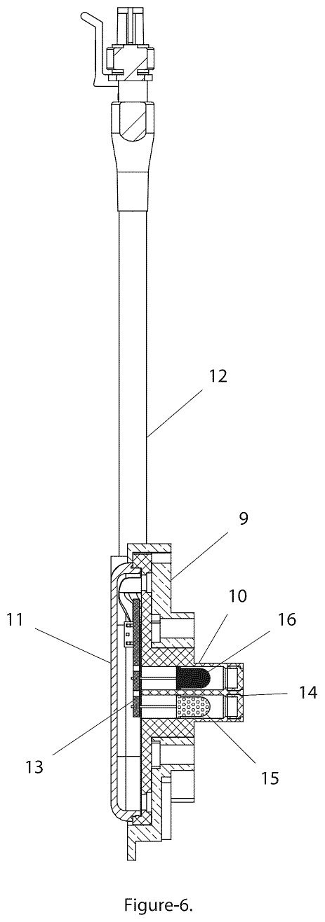

The cap (11) of the optical sensor device (8) is attached to the tubular housing with an infrared guide (10), which features a series of mechanical anchors arranged for this purpose. This arrangement provides support and stability for the electronic circuit (13) and the power and data cable (12). As a result, the optical sensor device (8) is formed into a completely sealed and independent unit that can be mounted onto its base (9) for subsequent installation on the appropriate implement (FIGS. 4 and 6).

### Technical Specifications of the Developed Optical Sensor

The optical sensor device (8) as a whole has the following technical specifications and operational parameters:
Operating Voltage: 8 to 32 [Vdc]
Nominal Power: 250 [mW]
Maximum Current: 150 [mA]
Power of the Emitting Infrared LED: 200 [mW]
Central Wavelength of the Emitter: 890 [nm]
Emission Angle: 16°
Central Wavelength of the Receiver: 890 [nm]
Maximum Detection Distance: 800 [mm]
Minimum Detection Distance: 2 [mm]
Operating Frequency: 100 [Hz] at 10% Duty Cycle

### Reported States:

ON: Blade-holding arm (4) is in its normal working position.
OFF: Blade-holding arm (4) is out of its working position, in a safety position due to the cutting of the safety pin (7).

### User-Configurable Parameters:

Operating Mode: Defines how the sensor interprets, processes, and reports signals.
Proximity: The distance at which a state change is considered.

### Operating Modes:

Normal Mode: Presence detection transmits ON
Inverted Mode: Presence detection transmits OFF

In the case of the infrared LED (15) and the receiving phototransistor (16), these technical characteristics are not limiting, as they can be adjusted to meet the specific requirements of a particular implement or design. This allows for power, operating wavelength, and/or emission angle variations without altering the operating principle or application.

There being no difference in detecting the proximity of the blade-holding arm (4) with respect to an optical sensor (8) between a mechanical weeder and a subsoiler, considering their structural characteristics, any agricultural implement that comprises at least one frame coupled to a support bracket that holds a plate or blade holder (4) is suitable for the installation of an optical sensor (8) to detect the distance within the configured range of limit values (minimum and/or maximum) between the optical sensor device (8) and the blade-holding arm (4).

### Operating Principle

In a Mechanical Weeder, the optical sensor device (8) along with its mounting base (9) is located on the support bracket (3) of the implement, as shown in FIG. 1. Once installed in its position, the optical sensor device (8) is connected using the power and data cable (12) to the implement's LIN network, which provides it with the necessary power to operate and connectivity to the control panel for configuring the parameters. This configuration is mandatory every time it is positioned for the first time on a new implement, after which it operates by reporting the corresponding status of the blade-holding arm (4) based on the adjusted configuration parameters.

Configuration: The user-configurable operational parameters must be adjusted each time an optical sensor device (8) is connected to a new implement.

Define the Operating Mode, which in a Mechanical Weeder is the Normal mode, meaning it reports an ON state when it detects the presence of the blade-holding arm (4) within the configured range. The detection distance from the optical sensor device (8) to the blade holder (4) that is considered normal is set by adjusting the user-configurable parameter called Proximity, which has a range extending from 2 mm to 800 millimeters of linear distance. This broad range of user-configurable detection enables the sensor to operate with varying sensitivities regarding the normal working position of the blade holder (4), which may experience natural oscillatory movements due to the working conditions to which it is exposed, in order to avoid reporting erroneous states.

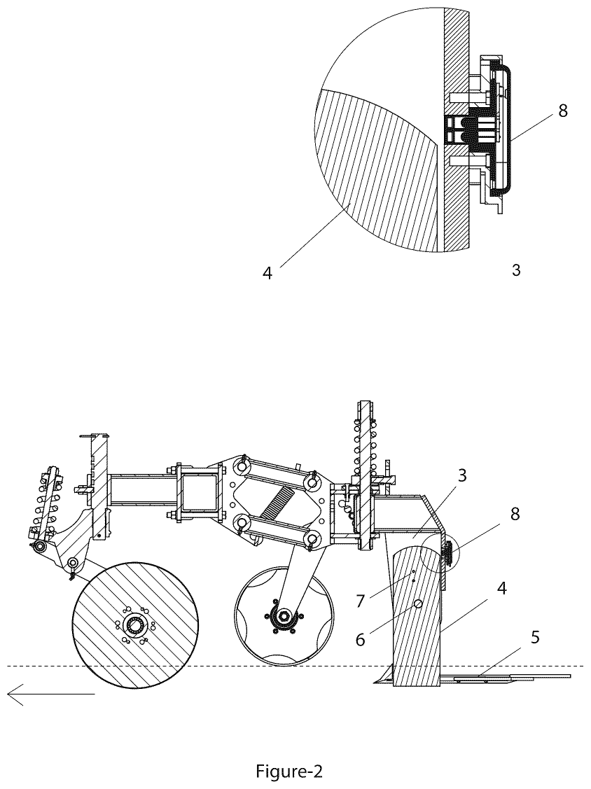

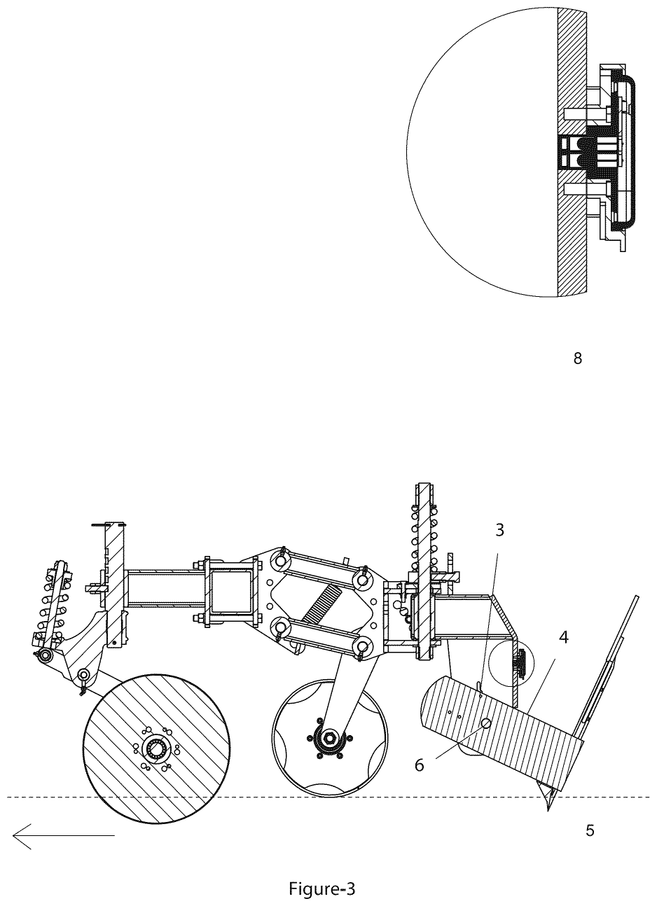

The Proximity parameter is adjusted based on the following procedure: first, the blade-holding arm (4) is placed in its correct working position, as illustrated in FIG. 2. A command is sent to the optical sensor device (8) via LIN to obtain the reading of the reflection detected by the infrared receiver (23) to calibrate the minimum distance of the blade holder (4). Next, the blade holder (4) is positioned in a location considered incorrect, as shown in FIG. 3), so that the optical sensor device (8) can adjust the Proximity value at which the state change occurs. This procedure is of utmost importance and necessity because the correct working position can generate different levels of signal reflection depending on each manufacturer's implement design, the metal paint, the level of corrosion, etc. Additionally, the incorrect working position may produce some reflections from the blade holder (4), albeit of lower intensity, making it essential to perform this procedure each time the optical sensor device (8) is installed on a new implement.

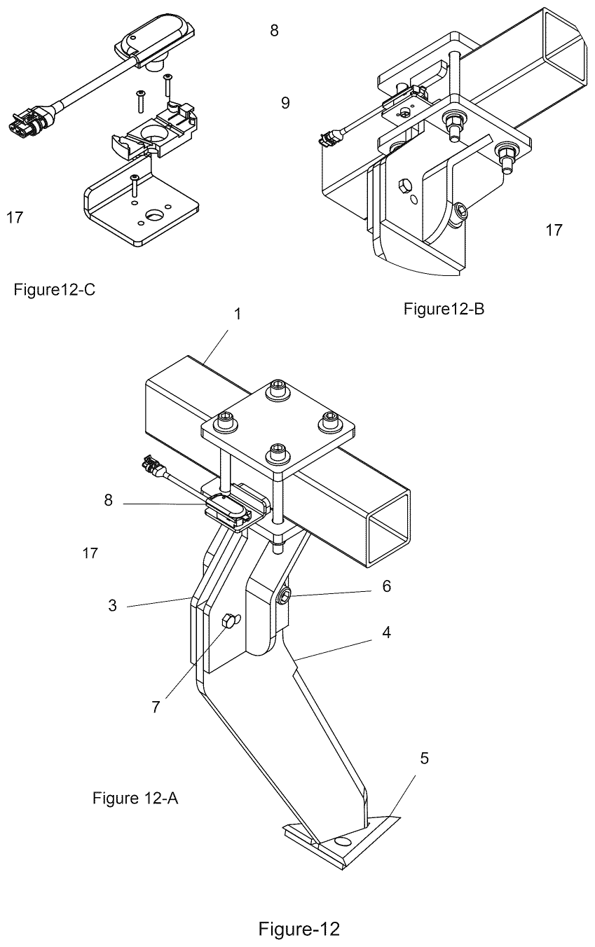

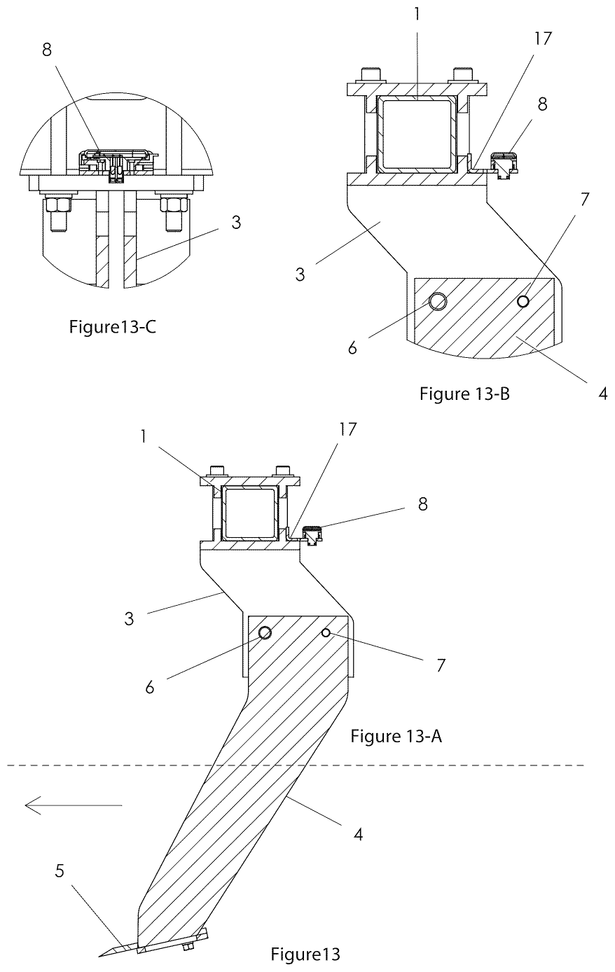

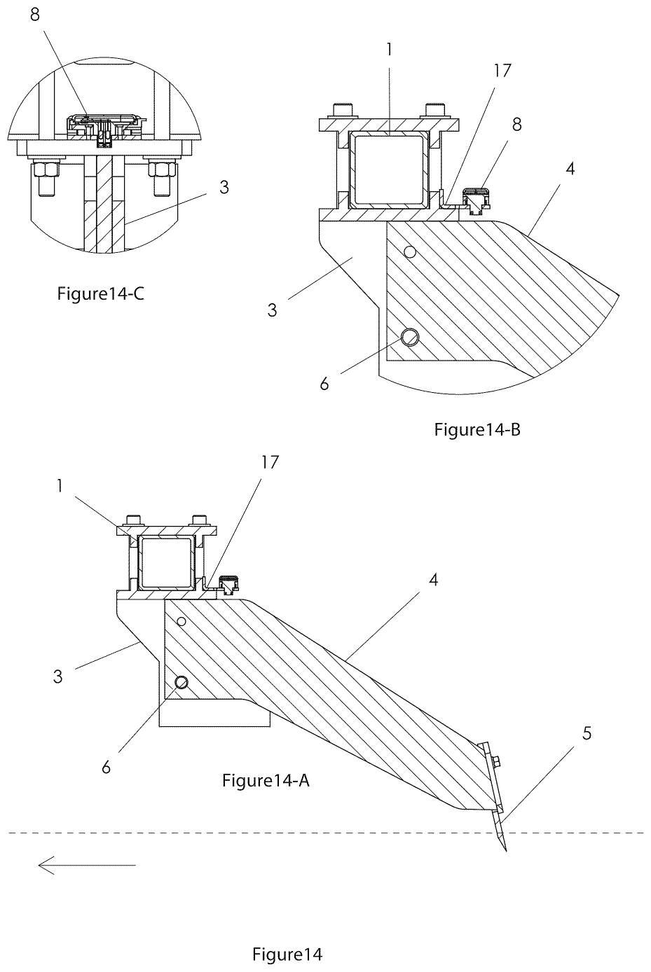

The same procedure is followed in a subsoiler, but starting from the premise that the optical sensor device (8) is configured to operate in Inverted Operating Mode. The tool's correct and incorrect working positions must then be calibrated, taking into account FIGS. 12 and 13, respectively.

The operating principle of the optical sensor device (8) is simple and robust, considering its error tolerance and durability in the face of adverse environmental conditions. The microcontroller (19) generates a pulse signal at a fixed frequency of 100 [Hz] with a 10% duty cycle, which enters the circuit of the infrared emitter (22) to enable the infrared LED (15) to emit the light signal. The light beams emitted by the infrared LED (15) travel through the tubular housing with an infrared guide (10), passing through the polycarbonate protective lens (14) before being reflected off the blade-holding arm (4). These beams return to the optical sensor device (8), again passing through the polycarbonate protective lens (14) and the tubular housing with an infrared guide (10) until they are detected by the receiving phototransistor (16). This component transforms the received light into an electrical signal, which is captured and processed by the signal amplifier (21) so that the microcontroller (19) can read, process, and interpret it. Based on the configuration parameters established by the user and stored in the internal memory of the microcontroller (19), the state (ON/OFF) is determined. This state is then communicated through the communication interface (20) and the power and data cable (12) in LIN format, allowing it to be interpreted by the control panel and reported to the operator in real time.

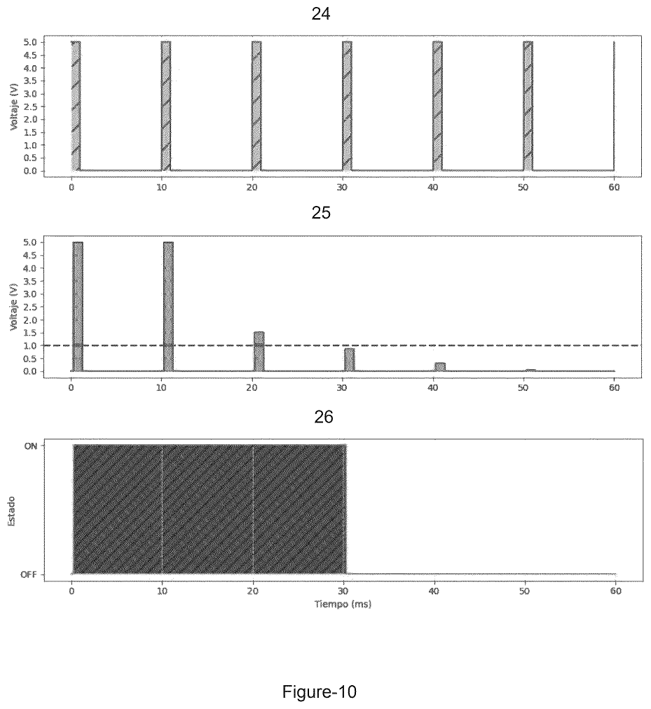

In a Mechanical Weeder, FIG. 10 shows the signal emitted by the infrared LED (24), the detected signal (25) that is processed in the microcontroller (19), and the interpretation of the detected state (26), considering that its mode of operation in this case is Normal mode, based on the Proximity threshold previously adjusted by the user. The time synchronization between the emitted signal (24) and the detected signal (25) can be observed; additionally, in the detected signal diagram (25), the amplitude captured with each received reflection is visible, along with how the amplitude varies as the blade-holding arm (4) moves away from the correct working position (FIG. 2) to the incorrect working position (FIG. 3). The dashed line indicates the proximity threshold set by the user, beyond which the state change from ON to OFF or vice versa is considered. The state diagram (26) shows how and when the state interpreted by the sensor changes, considering the adjusted Proximity value, which is reported to the control panel via the communication interface (20). It is observed that during the first three detected pulses, the amplitude decreases but remains above the Proximity threshold, which is interpreted as the ON state. Starting from the fourth pulse, the amplitude falls below the proximity threshold, which is interpreted as the OFF state.

In a subsoiler, FIG. 11 shows the signal emitted by the infrared LED (24), the detected signal (25) that is processed in the microcontroller (19), and the interpretation of the detected state (26), considering that its mode of operation in this case is the Inverted mode, also based on the Proximity threshold previously adjusted by the user. The time synchronization between the emitted signal (24) and the detected signal (25) can be observed. Additionally, in the detected signal diagram (25), the amplitude captured in each received reflection is shown, along with how the amplitude varies as the blade-holding arm (4) moves away from the correct working position (FIG. 12) to the incorrect working position (FIG. 13). The dashed line indicates the proximity threshold set by the user, beyond which a state change from ON to OFF or vice versa is considered. The state diagram (26) shows how and when the state interpreted by the sensor changes, considering the adjusted Proximity value, which is reported to the control panel via the communication interface (20). It is observed that in the initial emitted pulses, there is no reflection, resulting in no pulses detected, interpreted as the ON state. In the subsequent two detected pulses, the amplitude increases but remains below the Proximity threshold, which is still interpreted as the ON state. Starting from the third detected pulse, the amplitude exceeds the Proximity threshold, which is interpreted as the OFF state.

The electronic circuit (13) comprises the following subsystems, which are explained below:

A power supply (18) that regulates the input voltage, supporting an input voltage of up to 32 VDC, capable of providing up to 500 mA, stabilizing the operating voltage of the entire electronic circuit at 5 VDC, and protected by a diode in case of reverse voltage connection.

A microcontroller (19) with its developed firmware and all necessary auxiliary components, responsible for commanding all actions performed by the optical sensor device, including controlling the emission of light signals, digitizing and analyzing the received signals, making decisions regarding the states to be reported, adjusting and storing user-configurable parameters in its non-volatile internal memory, and managing bidirectional communications with the control panel. The microcontroller (19) generates a pulsing signal at a constant frequency of 100 [Hz] with a 10% duty cycle, which serves as the reference for analyzing the received signals. If the signals are out of sync with the set frequency or pulse width, they are discarded as spurious signals and do not affect the state change, providing robustness to detection. Signals that are in sync with the set frequency and pulse width are analyzed for amplitude to determine whether presence is detected at a distance defined by the user through the Proximity parameter, which sets the detection distance based on the amplitude of the received signal. If presence is detected, the state ON is reported via the Communication Interface (20), and the indicator LED is also turned on. If NO presence is detected, the state OFF is reported through the Communication Interface (20), and the indicator LED is turned off. This logic operates in exactly the opposite manner when the configured Operating Mode is Inverted, such as in the case of the subsoiler.

An infrared emitter (22) consisting of an infrared LED (15) with a power of 200 mW, a wavelength of 890 nm, an emission angle of 16°, and a transistor with all auxiliary components that enable the operation of the infrared LED (15) and serves as an interface with the microcontroller (19).

An infrared receiver (23) comprising a receiving phototransistor (16) from which the received light signal is taken, transformed into an electrical signal, and then transmitted to the signal amplifier (21), which consists of an operational amplifier with all necessary auxiliary components for analog filtering and adjusting the signal to levels that can be interpreted by the microcontroller (19).

A Communication Interface (20) comprises components that adjust the signal levels received and transmitted by the microcontroller (19) to comply with the physical layer specifications of the LIN communication protocol.

The tubular housing with an infrared guide (10), the cap (11), and the mounting base (9) are made of high-strength black plastic with UV protection to enhance their durability when exposed to impacts and adverse environmental conditions. During the assembly of the optical sensor device (8), encapsulation with epoxy resin is performed to provide protection and robustness to the electronic circuit (13), shielding it from impacts, vibrations, exposure to dust, moisture, and particles that could affect the sensitivity, durability, and/or precision of each of its components. The mounting base (9) is designed to be directly coupled to the support bracket (3) of the mechanical weeder or the coupling device (17) in the case of the subsoiler. Additionally, it features a design that allows the installation of the optical sensor device (8) without the need for added screws, ties, or any other fastening method, as the design includes mechanical connectors with latches specifically designed for this purpose.

The polycarbonate cover (14) is a protective casing made from loaded polycarbonate to achieve a narrowband filtering effect, allowing only a very limited range of specific wavelengths to pass through. Its purpose is to protect the infrared LED (15) and the receiving phototransistor (16) from external factors that could damage them or interfere with their functioning, preventing mechanical damage from impacts, dust, moisture, dirt, and particles that could affect the sensitivity or accuracy of both components. The properties of the loaded polycarbonate material used to manufacture the polycarbonate cover (14) help block or reduce the entry of ultraviolet radiation, preventing the degradation of both components and thereby extending their lifespan.

The power and data cable (12) consists of three multi-strand conductors, each with a cross-section of 1 mm², covered by a PVC sheath with UV protection to enhance durability. On one end, the conductors are soldered to the electronic circuit (13) at their respective locations, while on the other end, there is a polarized 3-pin female AMP connector, which connects to the central branch of the LIN network. To standardize the communication interfaces in the LIN network, the three multi-strand conductors that make up the power and data cable (12) are defined as follows: the RED wire is for positive power; the BLACK wire is for return or negative power; and the WHITE wire is for LIN communication signal. This communication format, using a single cable with the LIN protocol, allows for connecting up to 64 sensors in parallel without the need for concentrator nodes or communication signal amplifiers, which simplifies the architecture and installation of these sensors in agricultural implements.

Having thus specifically described and defined the nature of the present invention and the way it is to be implemented, the following is claimed as exclusive property and right:

1. An optical sensor device for detecting faults in mechanical weeders and subsoilers, supported by a support bracket attached to the frame, the optical sensor device (8) comprising:
a tubular housing with an infrared guide (10), inside which an electronic circuit (13) connected to a transmitting infrared LED (15) and a receiving phototransistor (16) arranged in parallel is housed;
wherein the tubular housing with the infrared guide (10) is protected by a polycarbonate protective lens (14) and closed with a cap (11);
wherein the optical sensor device (8) is fixed by a mounting base (9) and connected through a power and data cable (12), which is integrated into a LIN network linking it to an operator's control panel.

2. The optical sensor device; according to claim 1, wherein the electronic circuit (13) comprises a power supply (18), a microcontroller (19), a communication interface (20), a signal amplifier (21), an infrared emitter (22), and an infrared receiver (23).

3. The optical sensor device; according to claim 1, wherein the optical sensor (8) measures a distance between the optical sensor device (8) and a blade-holding arm within a configurable minimum and/or maximum range of values in an agricultural implement.

4. The optical sensor device; according to claim 1, wherein the optical sensor (8) is connected via a LIN network through the power and data cable (12), allowing communication of up to 64 optical sensor devices (8) with the operator's control panel.

5. The optical sensor device; according to claim 1, wherein the optical sensor (8) is coupled by the mounting base (9), positioned over and inserted into the support bracket (3) attached to the frame (1) of a mechanical weeder.

6. The optical sensor device; according to claim 1, wherein the optical sensor (8) coupled via the mounting base (9), is positioned both above and inside a coupling device (17), which is connected to the support bracket (3) attached to the frame (1) firmly integrated with a subsoiler.

7. The optical sensor device, according to claim 1, wherein the tubular housing with the infrared guide (10), the cap (11), and the mounting base (9) are made from a black color UV-protected “ABS” thermoplastic material.

8. The optical sensor device; according to claim 1, wherein the power and data cable (12) is mechanically linked at a first end to the electronic circuit (13) and at a second end connected to the LIN network.

9. The optical sensor device, according to claim 1, wherein the polycarbonate protective lens (14) comprises a polycarbonate cover with a charge, which integrates a narrow-band optical filter configured to select the range of electromagnetic radiation incident on the sensor.

10. The optical sensor device, according to claim 1, wherein the microcontroller (19) comprises a control logic stored in a non-volatile memory, and is configured to manage the adjustment and storage of parameters configurable by an user.

11. The optical sensor device; according to claim 2, wherein the microcontroller (19) generates a pulse signal at a fixed frequency of 100 [Hz] with a duty cycle of 10%.

12. The optical sensor device; according to claim 2, wherein the signal amplifier (21) is configured to provide the necessary means for reading, filtering, and conditioning the signal obtained from the infrared receiver (23), allowing its processing by the microcontroller (19).
